(19) United States
(12) Patent Application Publication
(10) Pub. No.: US 2016/0210780 A1
(43) Pub. Date: Jul. 21, 2016

(54) APPLYING REAL WORLD SCALE TO VIRTUAL CONTENT

(71) Applicants: Jonathan Paulovich, Redmond, WA (US); Johnathan Robert Bevis, Redmond, WA (US); Cameron G. Brown, Bellevue, WA (US); Jonathan Plumb, Seattle, WA (US); Daniel J. McCulloch, Kirkland, WA (US); Nicholas Gervase Fajt, Seattle, WA (US)

(72) Inventors: Jonathan Paulovich, Redmond, WA (US); Johnathan Robert Bevis, Redmond, WA (US); Cameron G. Brown, Bellevue, WA (US); Jonathan Plumb, Seattle, WA (US); Daniel J. McCulloch, Kirkland, WA (US); Nicholas Gervase Fajt, Seattle, WA (US)

(21) Appl. No.: 14/600,856

(22) Filed: Jan. 20, 2015

(51) Int. Cl. G06T 19/00; G06T 3/40; G06T 7/00; G02B 27/01

(52) U.S. Cl. CPC G06T 19/006; G02B 27/0172; G06T 3/40; G06T 7/0042; G02B 2027/0178

(57) ABSTRACT

A system and method are disclosed for scaled viewing, experiencing and interacting with a virtual workpiece in a mixed reality. The system includes an immersion mode, where the user is able to select a virtual avatar, which the user places somewhere in or adjacent a virtual workpiece. The view then displayed to the user may be that from the perspective of the avatar. The user is, in effect, immersed into the virtual content, and can view, experience, explore and interact with the workpiece in the virtual content on a life-size scale.

### BACKGROUND

Mixed reality is a technology that allows virtual imagery to be mixed with a real-world physical environment. A see-through, head mounted, mixed reality display device may be worn by a user to view the mixed imagery of real objects and virtual objects displayed in the user's field of view. Creating and working with virtual content can be challenging because it does not have inherent unit scale. Content creators typically define their own scale when creating content and expect others to consume it using the same scale. This in turn leads to difficultly understanding the relationship between virtual content scale and real world scale. It is further compounded when attempting to view virtual content using limited 2D displays and can also make detailed editing of content difficult.

### SUMMARY

Embodiments of the present technology relate to a system and method for viewing, exploring, experiencing and interacting with virtual content from a viewing perspective within the virtual content. A user is, in effect, shrunk down and inserted into virtual content so that the user may experience a life-size view of the virtual content. A system for creating virtual objects within a virtual environment in general includes a see-through, head mounted display device coupled to at least one processing unit. The processing unit in cooperation with the head mounted display device(s) are able to display a virtual workpiece that a user is working on or otherwise wishes to experience.

The present technology allows a user to select a mode of viewing a virtual workpiece, referred to herein as immersion mode. In immersion mode, the user is able to select a virtual avatar, which may be a scaled-down model of the user that the user places somewhere in or adjacent the virtual workpiece. At that point, the view displayed to the user is that from the perspective of the avatar. The user is, in effect, shrunk down and immersed into the virtual content. The user can view, explore, experience and interact with the workpiece in the virtual content on a life-size scale, for example with the workpiece appearing in a one-to-one size ratio with a size of the user in the real world.

In addition to getting a life-size perspective of the virtual workpiece, viewing the virtual workpiece in immersion mode provides greater precision in a user's interaction with the workpiece. For example, when viewing a virtual workpiece from actual real world space, referred to herein as real world mode, a user's ability to select and interact with a small virtual piece from among a number of small virtual pieces may be limited. However, when in immersion mode, the user is viewing a life size scale of the workpiece, and is able to interact with small pieces with greater precision.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of a virtual reality environment including real and virtual objects.

FIG. 2 is a perspective view of one embodiment of a head mounted display unit.

FIG. 3 is a side view of a portion of one embodiment of a head mounted display unit.

FIG. 4 is a block diagram of one embodiment of the components of a head mounted display unit.

FIG. 5 is a block diagram of one embodiment of the components of a processing unit associated with a head mounted display unit.

FIG. 6 is a block diagram of one embodiment of the software components of a processing unit associated with the head mounted display unit.

FIG. 7 is a flowchart showing the operation of one or more processing units associated with a head mounted display units of the present system.

FIGS. 8-12 are more detailed flowcharts of examples of various steps shown in the flowchart of FIG. 7.

FIGS. 13-16 illustrates examples of a user viewing a workpiece in a virtual environment from a real world mode

FIGS. 17-19 illustrate examples of a virtual environment viewed from within an immersion mode according to aspects of the present technology.

### DETAILED DESCRIPTION

Embodiments of the present technology will now be described with reference to the figures, which in general relate to a system and method for viewing, exploring, experiencing and interacting with virtual objects, also referred to herein as holograms, in a mixed reality environment from an immersed view of the virtual objects. In embodiments, the system and method may use a mobile mixed reality assembly to generate a three-dimensional mixed reality environment. The mixed reality assembly includes a mobile processing unit coupled to a head mounted display device (or other suitable apparatus) having a camera and a display element.

The processing unit may execute a scaled immersion software application, which allows a user to immerse him or herself into the virtual content, by inserting a user-controlled avatar into the virtual content and displaying the virtual content from the avatar's perspective. As described below, a user may interact with virtual objects of a virtual workpiece in both the real world and immersion modes.

The display element of the head mounted display device is to a degree transparent so that a user can look through the display element at real world objects within the user's field of view (FOV). The display element also provides the ability to project virtual images into the FOV of the user such that the virtual images may also appear alongside the real world objects. In the real world mode, the system automatically tracks where the user is looking so that the system can determine where to insert a virtual image in the FOV of the user. Once the system knows where to project the virtual image, the image is projected using the display element.

In the immersion mode, the user places a user-controlled avatar in the virtual content. The virtual content includes virtual workpiece(s) and areas appurtenant to the virtual workpiece(s). A virtual workpiece may be a partially constructed virtual object or set of objects that the user may view as they are being created. A virtual workpiece may also be a completed virtual object or set of objects that the user is viewing.

When operating in immersion mode, the system tracks where a user is looking in the real world, and then uses scaled immersion matrices to transform the displayed view of the virtual content to the scaled perspective of the virtual avatar. Movements of the user in the real world result in corresponding scaled changes in the avatar's view perspective in the immersed view. These features are explained below.

In embodiments, the processing unit may build a three-dimensional model of the environment including the x, y, z Cartesian positions of a user, real world objects and virtual three-dimensional objects in the room or other environment. The three-dimensional model may be generated by the mobile processing unit by itself, or working in tandem with other processing devices as explained hereinafter.

In the real world mode, the virtual content displayed to a user via the head mounted display device from the perspective of the head mounted display device and the user's own eyes. This perspective is referred to herein as a real world view. In the immersion mode, the viewing perspective is scaled, rotated translated to a position and orientation within the virtual content. This viewing perspective is referred to herein as an immersion view.

Conceptually, the immersion view is a view that an avatar would “see” once the avatar is positioned and sized by the user within the virtual content. The user may move the avatar as explained below, so that the virtual content that the avatar “sees” in the immersion view changes. At times herein, the immersion view is therefore described in terms of the avatar's view or perspective of the virtual content. However, from a software perspective, as explained below, the immersion view is a view frustum from a point xᵢ, yᵢ, zᵢ in Cartesian space, and a unit vector (pitchᵢ, yawᵢ and rollᵢ) from that point. As is also explained below, that point and unit vector are derived from an initial position and orientation of the avatar set by the user in the virtual content, as well as the scaled size of the avatar set by the user.

As described below, a user may interact with virtual objects of a virtual workpiece in both the real world and immersion modes. As used herein, the term “interact” encompasses both physical and verbal gestures. Physical gestures include a user performing a predefined gesture using his or her fingers, hands and/or other body parts recognized by the mixed reality system as a user command for the system to perform a predefined action. Such predefined gestures may include, but are not limited to, head targeting, eye targeting (gaze), pointing at, grabbing, pushing, resizing and shaping virtual objects.

Physical interaction may further include contact by the user with a virtual object. For example, a user may position his or her hands in three-dimensional space at a location corresponding to the position of a virtual object. The user may thereafter perform a gesture, such as grabbing or pushing, which is interpreted by the mixed reality system, and the corresponding action is performed on the virtual object, e.g., the object may be grabbed and may thereafter be carried in the hand of the user, or the object may be pushed and is moved an amount corresponding to the degree of the pushing motion. As a further example, a user can interact with a virtual button by pushing it.

A user may also physically interact with a virtual object with his or her eyes. In some instances, eye gaze data identifies where a user is focusing in the FOV, and can thus identify that a user is looking at a particular virtual object. Sustained eye gaze, or a blink or blink sequence, may thus be a physical interaction whereby a user selects one or more virtual objects.

A user may alternatively or additionally interact with virtual objects using verbal gestures, such as for example a spoken word or phrase recognized by the mixed reality system as a user command for the system to perform a predefined action. Verbal gestures may be used in conjunction with physical gestures to interact with one or more virtual objects in the virtual environment.

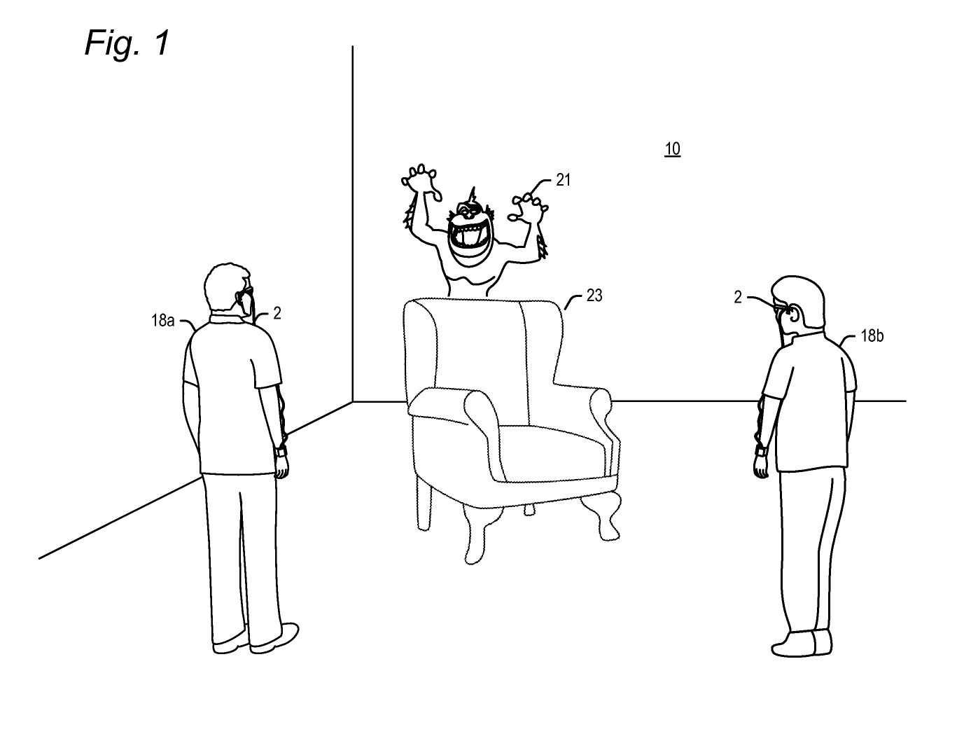

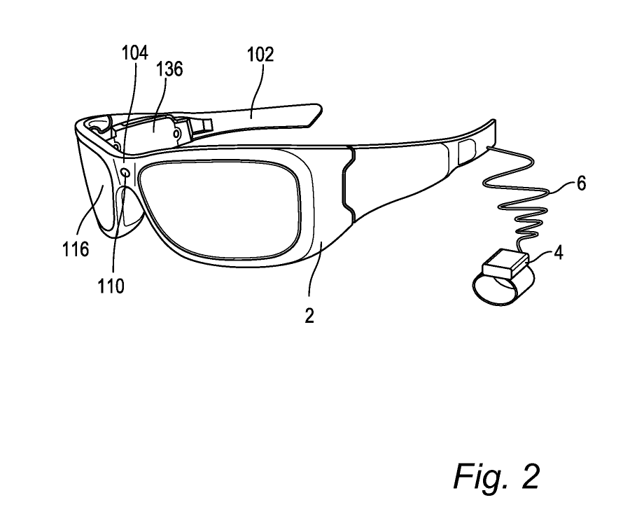

FIG. 1 illustrates a mixed reality environment 10 for providing a mixed reality experience to users by fusing virtual content 21 with real content 23 within each user's FOV. FIG. 1 shows two users 18a and 18b, each wearing a head mounted display device 2, and each viewing the virtual content 21 adjusted to their perspective. It is understood that the particular virtual content shown in FIG. 1 is by way of example only, and may be any of a wide variety of virtual objects forming a virtual workpiece as explained below. As shown in FIG. 2, each head mounted display device 2 may include or be in communication with its own processing unit 4, for example via a flexible wire 6. The head mounted display device may alternatively communicate wirelessly with the processing unit 4. In further embodiments, the processing unit 4 may be integrated into the head mounted display device 2. Head mounted display device 2, which in one embodiment is in the shape of glasses, is worn on the head of a user so that the user can see through a display and thereby have an actual direct view of the space in front of the user. More details of the head mounted display device 2 and processing unit 4 are provided below.

Where not incorporated into the head mounted display device 2, the processing unit 4 may be a small, portable device for example worn on the user's wrist or stored within a user's pocket. The processing unit 4 may include hardware components and/or software components to execute applications such as gaming applications, non-gaming applications, or the like. In one embodiment, processing unit 4 may include a processor such as a standardized processor, a specialized processor, a microprocessor, or the like that may execute instructions stored on a processor readable storage device for performing the processes described herein. In embodiments, the processing unit 4 may communicate wirelessly (e.g., WiFi, Bluetooth, infra-red, or other wireless communication means) to one or more remote computing systems. These remote computing systems may including a computer, a gaming system or console, or a remote service provider.

The head mounted display device 2 and processing unit 4 may cooperate with each other to present virtual content 21 to a user in a mixed reality environment 10. The details of the present system for building virtual objects are explained below. The details of the mobile head mounted display device 2 and processing unit 4 which enable the building of virtual objects will now be explained with reference to FIGS. 2-6.

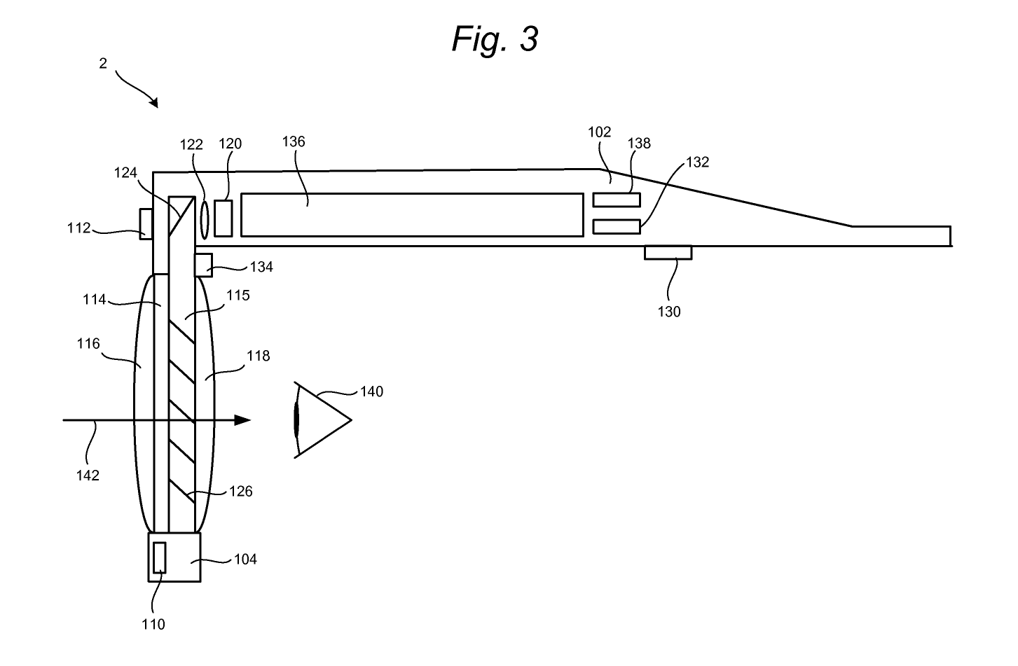

FIGS. 2 and 3 show perspective and side views of the head mounted display device 2. FIG. 3 shows only the right side of head mounted display device 2, including a portion of the device having temple 102 and nose bridge 104. Built into nose bridge 104 is a microphone 110 for recording sounds and transmitting that audio data to processing unit 4, as described below. At the front of head mounted display device 2 is room-facing video camera 112 that can capture video and still images. Those images are transmitted to processing unit 4, as described below.

A portion of the frame of head mounted display device 2 will surround a display (that includes one or more lenses). In order to show the components of head mounted display device 2, a portion of the frame surrounding the display is not depicted. The display includes a light-guide optical element 115, opacity filter 114, see-through lens 116 and see-through lens 118. In one embodiment, opacity filter 114 is behind and aligned with see-through lens 116, light-guide optical element 115 is behind and aligned with opacity filter 114, and see-through lens 118 is behind and aligned with light-guide optical element 115. See-through lenses 116 and 118 are standard lenses used in eye glasses and can be made to any prescription (including no prescription). In one embodiment, see-through lenses 116 and 118 can be replaced by a variable prescription lens. Opacity filter 114 filters out natural light (either on a per pixel basis or uniformly) to enhance the contrast of the virtual imagery. Light-guide optical element 115 channels artificial light to the eye. More details of opacity filter 114 and light-guide optical element 115 are provided below.

Mounted to or inside temple 102 is an image source, which (in one embodiment) includes microdisplay 120 for projecting a virtual image and lens 122 for directing images from microdisplay 120 into light-guide optical element 115. In one embodiment, lens 122 is a collimating lens.

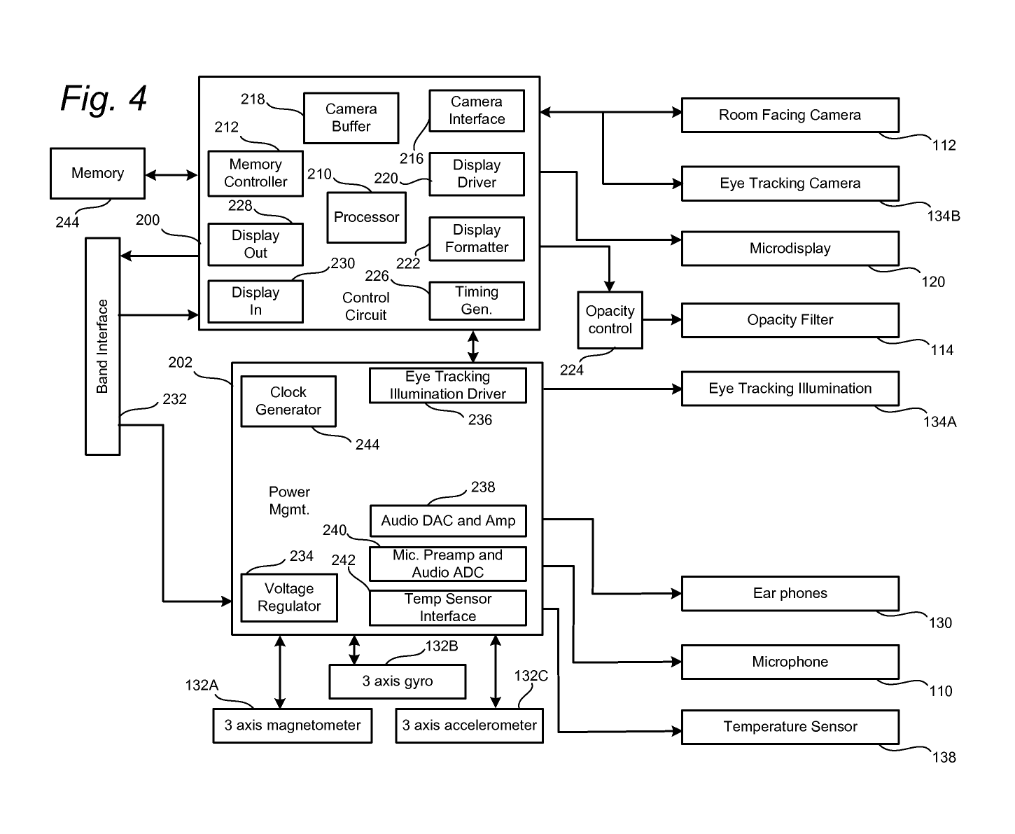

Control circuits 136 provide various electronics that support the other components of head mounted display device 2. More details of control circuits 136 are provided below with respect to FIG. 4. Inside or mounted to temple 102 are ear phones 130, inertial measurement unit 132 and temperature sensor 138. In one embodiment shown in FIG. 4, the inertial measurement unit 132 (or IMU 132) includes inertial sensors such as a three axis magnetometer 132A, three axis gyro 132B and three axis accelerometer 132C. The inertial measurement unit 132 senses position, orientation, and sudden accelerations (pitch, roll and yaw) of head mounted display device 2. The IMU 132 may include other inertial sensors in addition to or instead of magnetometer 132A, gyro 132B and accelerometer 132C.

Microdisplay 120 projects an image through lens 122. There are different image generation technologies that can be used to implement microdisplay 120. For example, microdisplay 120 can be implemented in using a transmissive projection technology where the light source is modulated by optically active material, backlit with white light. These technologies are usually implemented using LCD type displays with powerful backlights and high optical energy densities. Microdisplay 120 can also be implemented using a reflective technology for which external light is reflected and modulated by an optically active material. The illumination is forward lit by either a white source or RGB source, depending on the technology. Digital light processing (DLP), liquid crystal on silicon (LCOS) and Mirasol® display technology from Qualcomm, Inc. are examples of reflective technologies which are efficient as most energy is reflected away from the modulated structure and may be used in the present system. Additionally, microdisplay 120 can be implemented using an emissive technology where light is generated by the display. For example, a PicoP™ display engine from Microvision, Inc. emits a laser signal with a micro mirror steering either onto a tiny screen that acts as a transmissive element or beamed directly into the eye (e.g., laser).

Light-guide optical element 115 transmits light from microdisplay 120 to the eye 140 of the user wearing head mounted display device 2. Light-guide optical element 115 also allows light from in front of the head mounted display device 2 to be transmitted through light-guide optical element 115 to eye 140, as depicted by arrow 142, thereby allowing the user to have an actual direct view of the space in front of head mounted display device 2 in addition to receiving a virtual image from microdisplay 120. Thus, the walls of light-guide optical element 115 are see-through. Light-guide optical element 115 includes a first reflecting surface 124 (e.g., a mirror or other surface). Light from microdisplay 120 passes through lens 122 and becomes incident on reflecting surface 124. The reflecting surface 124 reflects the incident light from the microdisplay 120 such that light is trapped inside a planar substrate comprising light-guide optical element 115 by internal reflection. After several reflections off the surfaces of the substrate, the trapped light waves reach an array of selectively reflecting surfaces 126. Note that only one of the five surfaces is labeled 126 to prevent over-crowding of the drawing. Reflecting surfaces 126 couple the light waves incident upon those reflecting surfaces out of the substrate into the eye 140 of the user.

As different light rays will travel and bounce off the inside of the substrate at different angles, the different rays will hit the various reflecting surfaces 126 at different angles. Therefore, different light rays will be reflected out of the substrate by different ones of the reflecting surfaces. The selection of which light rays will be reflected out of the substrate by which surface 126 is engineered by selecting an appropriate angle of the surfaces 126. More details of a light-guide optical element can be found in United States Patent Publication No. 2008/0285140, entitled “Substrate-Guided Optical Devices,” published on Nov. 20, 2008. In one embodiment, each eye will have its own light-guide optical element 115. When the head mounted display device 2 has two light-guide optical elements, each eye can have its own microdisplay 120 that can display the same image in both eyes or different images in the two eyes. In another embodiment, there can be one light-guide optical element which reflects light into both eyes.

Opacity filter 114, which is aligned with light-guide optical element 115, selectively blocks natural light, either uniformly or on a per-pixel basis, from passing through light-guide optical element 115. Details of an example of opacity filter 114 are provided in U.S. Patent Publication No. 2012/0068913 to Bar-Zeev et al., entitled “Opacity Filter For See-Through Mounted Display,” filed on Sep. 21, 2010. However, in general, an embodiment of the opacity filter 114 can be a see-through LCD panel, an electrochromic film, or similar device which is capable of serving as an opacity filter. Opacity filter 114 can include a dense grid of pixels, where the light transmissivity of each pixel is individually controllable between minimum and maximum transmissivities. While a transmissivity range of 0-100% is ideal, more limited ranges are also acceptable, such as for example about 50% to 90% per pixel.

A mask of alpha values can be used from a rendering pipeline, after z-buffering with proxies for real-world objects. When the system renders a scene for the mixed reality display, it takes note of which real-world objects are in front of which virtual objects as explained below. If a virtual object is in front of a real-world object, then the opacity may be on for the coverage area of the virtual object. If the virtual object is (virtually) behind a real-world object, then the opacity may be off, as well as any color for that pixel, so the user will see just the real-world object for that corresponding area (a pixel or more in size) of real light. Coverage would be on a pixel-by-pixel basis, so the system could handle the case of part of a virtual object being in front of a real-world object, part of the virtual object being behind the real-world object, and part of the virtual object being coincident with the real-world object. Displays capable of going from 0% to 100% opacity at low cost, power, and weight are the most desirable for this use. Moreover, the opacity filter can be rendered in color, such as with a color LCD or with other displays such as organic LEDs.

Head mounted display device 2 also includes a system for tracking the position of the user's eyes. As will be explained below, the system will track the user's position and orientation so that the system can determine the FOV of the user. However, a human will not perceive everything in front of them. Instead, a user's eyes will be directed at a subset of the environment. Therefore, in one embodiment, the system will include technology for tracking the position of the user's eyes in order to refine the measurement of the FOV of the user. For example, head mounted display device 2 includes eye tracking assembly 134 (FIG. 3), which has an eye tracking illumination device 134A and eye tracking camera 134B (FIG. 4). In one embodiment, eye tracking illumination device 134A includes one or more infrared (IR) emitters, which emit IR light toward the eye. Eye tracking camera 134B includes one or more cameras that sense the reflected IR light. The position of the pupil can be identified by known imaging techniques which detect the reflection of the cornea. For example, see U.S. Pat. No. 7,401,920, entitled “Head Mounted Eye Tracking and Display System”, issued Jul. 22, 2008. Such a technique can locate a position of the center of the eye relative to the tracking camera. Generally, eye tracking involves obtaining an image of the eye and using computer vision techniques to determine the location of the pupil within the eye socket. In one embodiment, it is sufficient to track the location of one eye since the eyes usually move in unison. However, it is possible to track each eye separately.

In one embodiment, the system will use four IR LEDs and four IR photo detectors in rectangular arrangement so that there is one IR LED and IR photo detector at each corner of the lens of head mounted display device 2. Light from the LEDs reflect off the eyes. The amount of infrared light detected at each of the four IR photo detectors determines the pupil direction. That is, the amount of white versus black in the eye will determine the amount of light reflected off the eye for that particular photo detector. Thus, the photo detector will have a measure of the amount of white or black in the eye. From the four samples, the system can determine the direction of the eye.

Another alternative is to use four infrared LEDs as discussed above, but just one infrared CCD on the side of the lens of head mounted display device 2. The CCD may use a small mirror and/or lens (fish eye) such that the CCD can image up to 75% of the visible eye from the glasses frame. The CCD will then sense an image and use computer vision to find the image, much like as discussed above. Thus, although FIG. 3 shows one assembly with one IR transmitter, the structure of FIG. 3 can be adjusted to have four IR transmitters and/or four IR sensors. More or less than four IR transmitters and/or four IR sensors can also be used.

Another embodiment for tracking the direction of the eyes is based on charge tracking. This concept is based on the observation that a retina carries a measurable positive charge and the cornea has a negative charge. Sensors are mounted by the user's ears (near earphones 130) to detect the electrical potential while the eyes move around and effectively read out what the eyes are doing in real time. Other embodiments for tracking eyes can also be used.

FIG. 3 only shows half of the head mounted display device 2. A full head mounted display device may include another set of see-through lenses, another opacity filter, another light-guide optical element, another microdisplay 120, another lens 122, room-facing camera, eye tracking assembly 134, earphones, and temperature sensor.

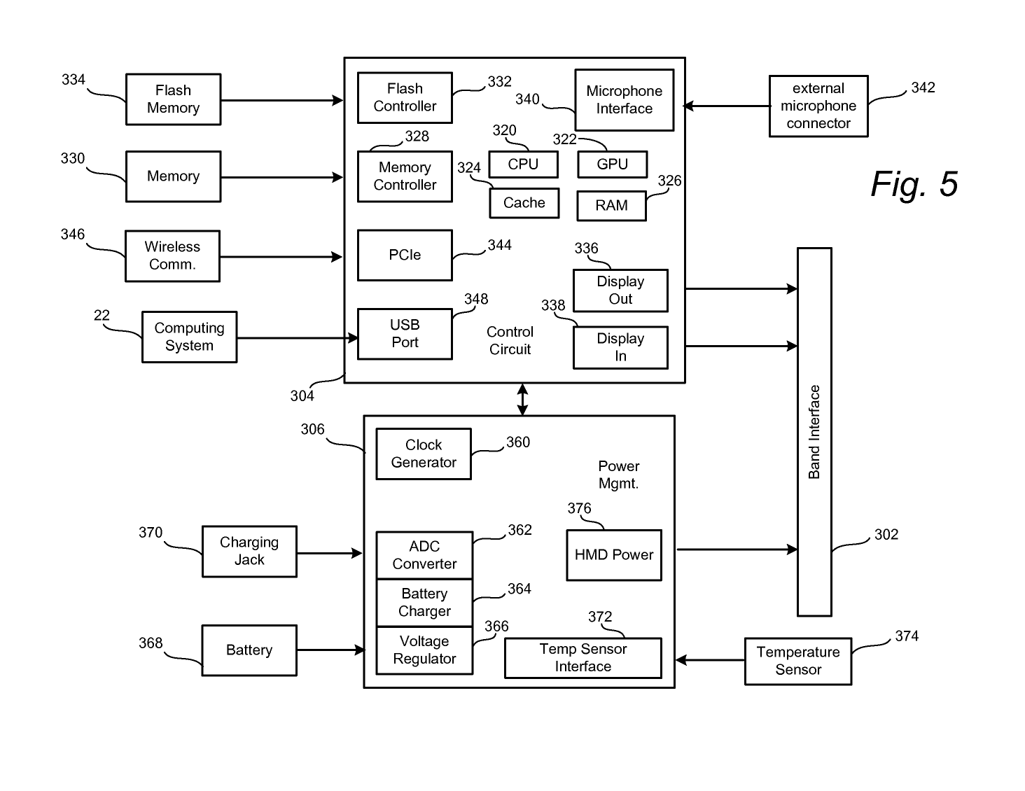

FIG. 4 is a block diagram depicting the various components of head mounted display device 2. FIG. 5 is a block diagram describing the various components of processing unit 4. Head mounted display device 2, the components of which are depicted in FIG. 4, is used to provide a virtual experience to the user by fusing one or more virtual images seamlessly with the user's view of the real world. Additionally, the head mounted display device components of FIG. 4 include many sensors that track various conditions. Head mounted display device 2 will receive instructions about the virtual image from processing unit 4 and will provide the sensor information back to processing unit 4. Processing unit 4 may determine where and when to provide a virtual image to the user and send instructions accordingly to the head mounted display device of FIG. 4.

Some of the components of FIG. 4 (e.g., room-facing camera 112, eye tracking camera 134B, microdisplay 120, opacity filter 114, eye tracking illumination 134A, earphones 130, and temperature sensor 138) are shown in shadow to indicate that there are two of each of those devices, one for the left side and one for the right side of head mounted display device 2. FIG. 4 shows the control circuit 200 in communication with the power management circuit 202. Control circuit 200 includes processor 210, memory controller 212 in communication with memory 214 (e.g., D-RAM), camera interface 216, camera buffer 218, display driver 220, display formatter 222, timing generator 226, display out interface 228, and display in interface 230.

In one embodiment, the components of control circuit 200 are in communication with each other via dedicated lines or one or more buses. In another embodiment, the components of control circuit 200 is in communication with processor 210. Camera interface 216 provides an interface to the two room-facing cameras 112 and stores images received from the room-facing cameras in camera buffer 218. Display driver 220 will drive microdisplay 120. Display formatter 222 provides information, about the virtual image being displayed on microdisplay 120, to opacity control circuit 224, which controls opacity filter 114. Timing generator 226 is used to provide timing data for the system. Display out interface 228 is a buffer for providing images from room-facing cameras 112 to the processing unit 4. Display in interface 230 is a buffer for receiving images such as a virtual image to be displayed on microdisplay 120. Display out interface 228 and display in interface 230 communicate with band interface 232 which is an interface to processing unit 4.

Power management circuit 202 includes voltage regulator 234, eye tracking illumination driver 236, audio DAC and amplifier 238, microphone preamplifier and audio ADC 240, temperature sensor interface 242 and clock generator 244. Voltage regulator 234 receives power from processing unit 4 via band interface 232 and provides that power to the other components of head mounted display device 2. Eye tracking illumination driver 236 provides the IR light source for eye tracking illumination 134A, as described above. Audio DAC and amplifier 238 output audio information to the earphones 130. Microphone preamplifier and audio ADC 240 provides an interface for microphone 110. Temperature sensor interface 242 is an interface for temperature sensor 138. Power management circuit 202 also provides power and receives data back from three axis magnetometer 132A, three axis gyro 132B and three axis accelerometer 132C.

FIG. 5 is a block diagram describing the various components of processing unit 4. FIG. 5 shows control circuit 304 in communication with power management circuit 306. Control circuit 304 includes a central processing unit (CPU) 320, graphics processing unit (GPU) 322, cache 324, RAM 326, memory controller 328 in communication with memory 330 (e.g., D-RAM), flash memory controller 332 in communication with flash memory 334 (or other type of non-volatile storage), display out buffer 336 in communication with head mounted display device 2 via band interface 302 and band interface 232, display in buffer 338 in communication with head mounted display device 2 via band interface 302 and band interface 232, microphone interface 340 in communication with an external microphone connector 342 for connecting to a microphone, PCI express interface for connecting to a wireless communication device 346, and USB port(s) 348. In one embodiment, wireless communication device 346 can include a Wi-Fi enabled communication device, BlueTooth communication device, infrared communication device, etc. The USB port can be used to dock the processing unit 4 to processing unit computing system 22 in order to load data or software onto processing unit 4, as well as charge processing unit 4. In one embodiment, CPU 320 and GPU 322 are the main workhorses for determining where, when and how to insert virtual three-dimensional objects into the view of the user. More details are provided below.

Power management circuit 306 includes clock generator 360, analog to digital converter 362, battery charger 364, voltage regulator 366, head mounted display power source 376, and temperature sensor interface 372 in communication with temperature sensor 374 (possibly located on the wrist band of processing unit 4). Analog to digital converter 362 is used to monitor the battery voltage, the temperature sensor and control the battery charging function. Voltage regulator 366 is in communication with battery 368 for supplying power to the system. Battery charger 364 is used to charge battery 368 (via voltage regulator 366) upon receiving power from charging jack 370. HMD power source 376 provides power to the head mounted display device 2.

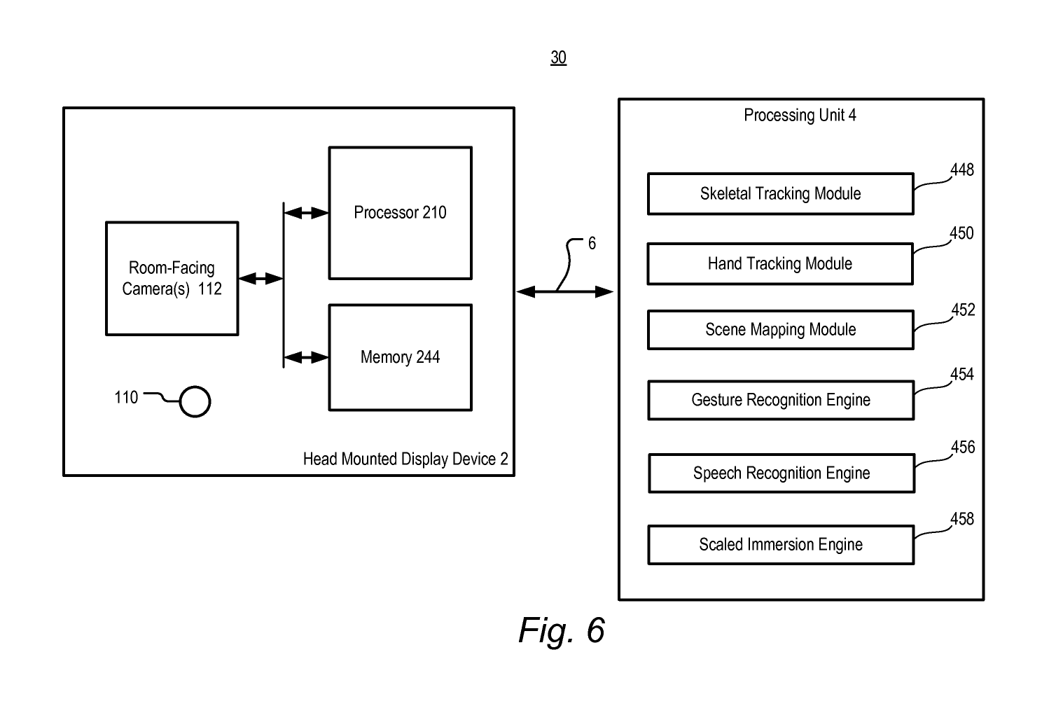

FIG. 6 illustrates a high-level block diagram of the mobile mixed reality assembly 30 including the room-facing camera 112 of the display device 2 and some of the software modules on the processing unit 4. Some or all of these software modules may alternatively be implemented on a processor 210 of the head mounted display device 2. As shown, the room-facing camera 112 provides image data to the processor 210 in the head mounted display device 2. In one embodiment, the room-facing camera 112 may include a depth camera, an RGB camera and an IR light component to capture image data of a scene. As explained below, the room-facing camera 112 may include less than all of these components.

Using for example time-of-flight analysis, the IR light component may emit an infrared light onto the scene and may then use sensors (not shown) to detect the backscattered light from the surface of one or more objects in the scene using, for example, the depth camera and/or the RGB camera. In some embodiments, pulsed infrared light may be used such that the time between an outgoing light pulse and a corresponding incoming light pulse may be measured and used to determine a physical distance from the room-facing camera 112 to a particular location on the objects in the scene, including for example a user's hands. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the room-facing camera 112 to a particular location on the objects by analyzing the intensity of the reflected beam of light over time via various techniques including, for example, shuttered light pulse imaging.

In another example embodiment, the room-facing camera 112 may use a structured light to capture depth information. In such an analysis, patterned light (i.e., light displayed as a known pattern such as a grid pattern, a stripe pattern, or different pattern) may be projected onto the scene via, for example, the IR light component. Upon striking the surface of one or more targets or objects in the scene, the pattern may become deformed in response. Such a deformation of the pattern may be captured by, for example, the 3-D camera and/or the RGB camera (and/or other sensor) and may then be analyzed to determine a physical distance from the room-facing camera 112 to a particular location on the objects. In some implementations, the IR light component is displaced from the depth and/or RGB cameras so triangulation can be used to determined distance from depth and/or RGB cameras. In some implementations, the room-facing camera 112 may include a dedicated IR sensor to sense the IR light, or a sensor with an IR filter.

It is understood that the present technology may sense objects and three-dimensional positions of the objects without each of a depth camera, RGB camera and IR light component. In embodiments, the room-facing camera 112 may for example work with just a standard image camera (RGB or black and white). Such embodiments may operate by a variety of image tracking techniques used individually or in combination. For example, a single, standard image room-facing camera 112 may use feature identification and tracking. That is, using the image data from the standard camera, it is possible to extract interesting regions, or features, of the scene. By looking for those same features over a period of time, information for the objects may be determined in three-dimensional space.

In embodiments, the head mounted display device 2 may include two spaced apart standard image room-facing cameras 112. In this instance, depth to objects in the scene may be determined by the stereo effect of the two cameras. Each camera can image some overlapping set of features, and depth can be computed from the parallax difference in their views.

A further method for determining a real world model with positional information within an unknown environment is known as simultaneous localization and mapping (SLAM). One example of SLAM is disclosed in U.S. Pat. No. 7,774,158, entitled “Systems and Methods for Landmark Generation for Visual Simultaneous Localization and Mapping.” Additionally, data from the IMU can be used to interpret visual tracking data more accurately.

The processing unit 4 may include a real world modeling module 452. Using the data from the front-facing camera(s) 112 as described above, the real world modeling module is able to map objects in the scene (including one or both of the user's hands) to a three-dimensional frame of reference. Further details of the real world modeling module are described below.

In order to track the position of users within a scene, users may be recognized from image data. The processing unit 4 may implement a skeletal recognition and tracking module 448. An example of a skeletal tracking module 448 is disclosed in U.S. Patent Publication No. 2012/0162065, entitled, “Skeletal Joint Recognition And Tracking System.” Such systems may also track a user's hands. However, in embodiments, the processing unit 4 may further execute a hand recognition and tracking module 450. The module 450 receives the image data from the room-facing camera 112 and is able to identify a user's hand, and a position of the user's hand, in the FOV. An example of the hand recognition and tracking module 450 is disclosed in U.S. Patent Publication No. 2012/0308140, entitled, “System for Recognizing an Open or Closed Hand.” In general the module 450 may examine the image data to discern width and length of objects which may be fingers, spaces between fingers and valleys where fingers come together so as to identify and track a user's hands in their various positions.

The processing unit 4 may further include a gesture recognition engine 454 for receiving skeletal model and/or hand data for one or more users in the scene and determining whether the user is performing a predefined gesture or application-control movement affecting an application running on the processing unit 4. More information about gesture recognition engine 454 can be found in U.S. patent application Ser. No. 12/422,661, entitled “Gesture Recognizer System Architecture,” filed on Apr. 13, 2009.

As mentioned above, a user may perform various verbal gestures, for example in the form of spoken commands to select objects and possibly modify those objects. Accordingly, the present system further includes a speech recognition engine 456. The speech recognition engine 456 may operate according to any of various known technologies.

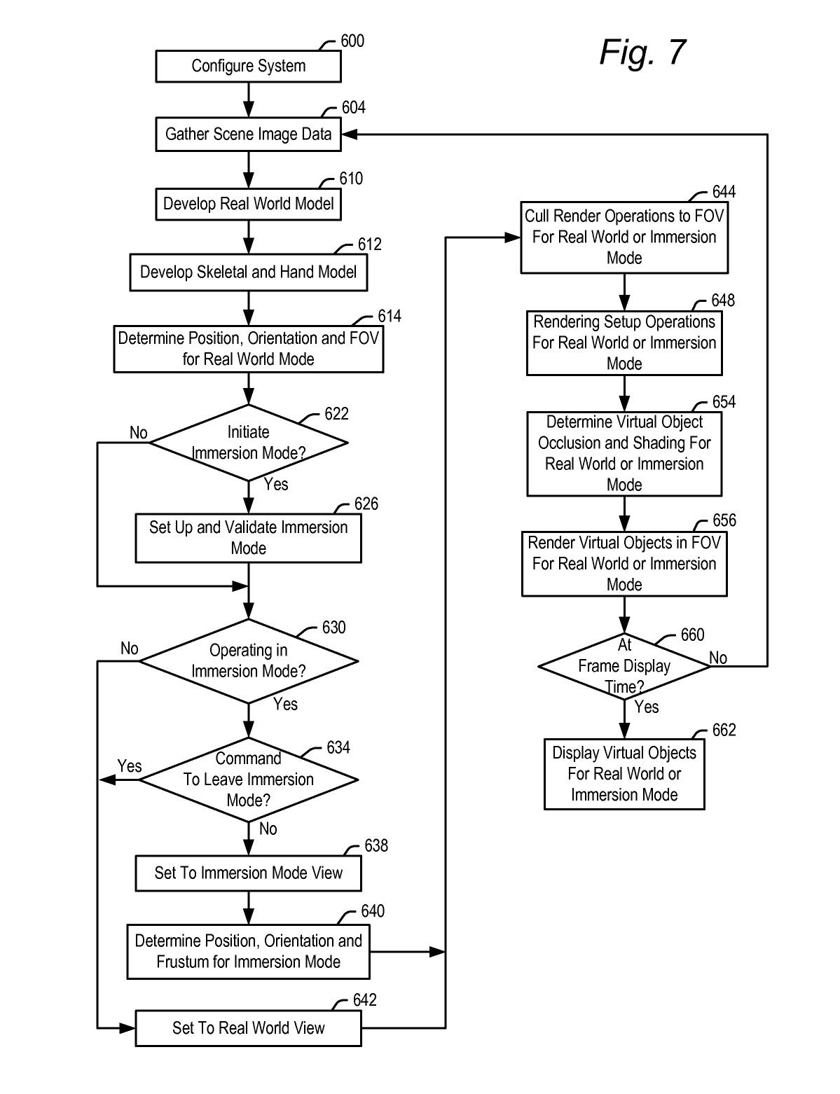

In one example embodiment, the head mounted display device 2 and processing unit 4 work together to create the real world model of the environment that the user is in and tracks various moving or stationary objects in that environment. In addition, the processing unit 4 tracks the FOV of the head mounted display device 2 worn by the user 18 by tracking the position and orientation of the head mounted display device 2. Sensor information, for example from the room-facing cameras 112 and IMU 132, obtained by head mounted display device 2 is transmitted to processing unit 4. The processing unit 4 processes the data and updates the real world model. The processing unit 4 further provides instructions to head mounted display device 2 on where, when and how to insert any virtual three-dimensional objects. In accordance with the present technology, the processing unit 4 further implements a scaled immersion software engine 458 for displaying the virtual content to a user via the head mounted display device 2 from the perspective of an avatar in the virtual content. Each of the above-described operations will now be described in greater detail with reference to the flowchart of FIG. 7.

FIG. 7 is high level flowchart of the operation and interactivity of the processing unit 4 and head mounted display device 2 during a discrete time period such as the time it takes to generate, render and display a single frame of image data to each user. In embodiments, data may be refreshed at a rate of 60 Hz, though it may be refreshed more often or less often in further embodiments.

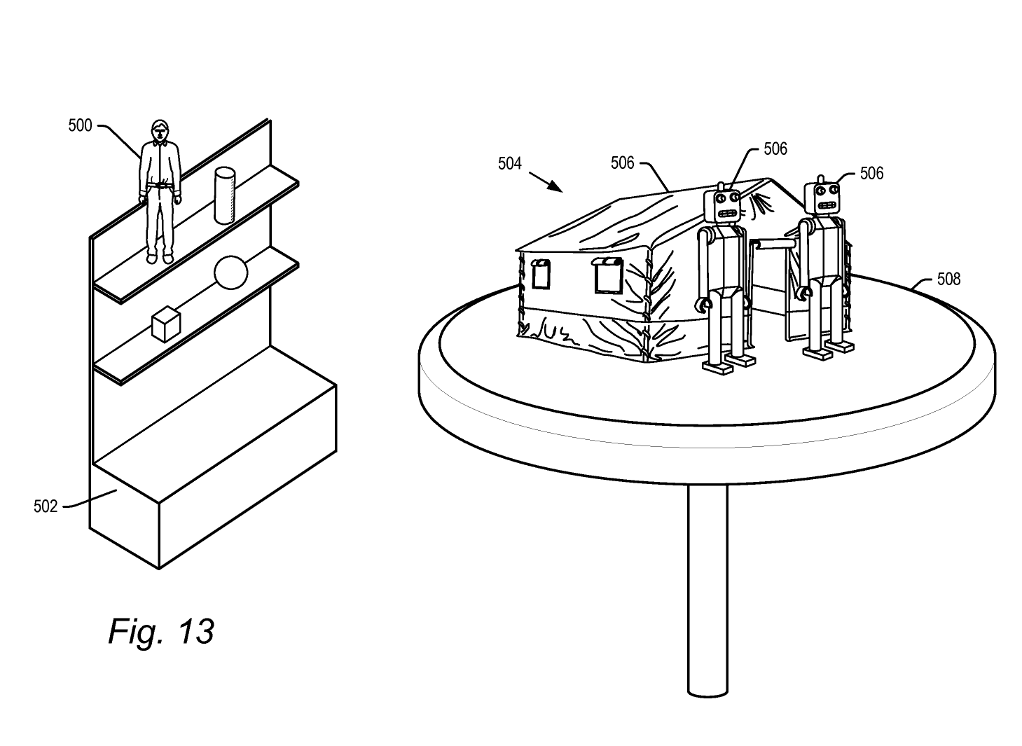

The system for presenting a virtual environment to one or more users 18 may be configured in step 600. In accordance with aspects of the present technology, step 600 may include retrieving a virtual avatar of the user from memory, such as for example the avatar 500 shown in FIG. 13. In embodiments, if not already stored, the avatar 500 may be generated by the processing unit 4 and head mounted display device 2 at step 604 explained below. The avatar may be a replica of the user (captured previously or in present time) and then stored. In further embodiments, the avatar need not be a replica of the user. The avatar 500 may be a replica of another person or a generic person. In further embodiments, the avatar 500 may be objects having an appearance other than a person.

In steps 604, the processing unit 4 gathers data from the scene. This may be image data sensed by the head mounted display device 2, and in particular, by the room-facing cameras 112, the eye tracking assemblies 134 and the IMU 132. In embodiments, step 604 may include scanning the user to render an avatar of the user as explained below, as well as to determine a height of the user. As explained below, the height of a user may be used to determine a scaling ratio of the avatar once sized and placed in a virtual content. Step 604 may further include scanning a room in which the user is operating the mobile mixed reality assembly 30, and determining its dimensions. As explained below, known room dimensions may be used to determine whether the scaled size and position of an avatar will allow a user to fully explore the virtual content in which the avatar is placed.

A real world model may be developed in step 610 identifying the geometry of the space in which the mobile mixed reality assembly 30 is used, as well as the geometry and positions of objects within the scene. In embodiments, the real world model generated in a given frame may include the x, y and z positions of a user's hand(s), other real world objects and virtual objects in the scene. Methods for gathering depth and position data have been explained above.

The processing unit 4 may next translate the image data points captured by the sensors into an orthogonal 3-D real world model, or map, of the scene. This orthogonal 3-D real world model may be a point cloud map of all image data captured by the head mounted display device cameras in an orthogonal x, y, z Cartesian coordinate system. Methods using matrix transformation equations for translating camera view to an orthogonal 3-D world view are known. See, for example, David H. Eberly, “3d Game Engine Design: A Practical Approach To Real-Time Computer Graphics,” Morgan Kaufman Publishers (2000).

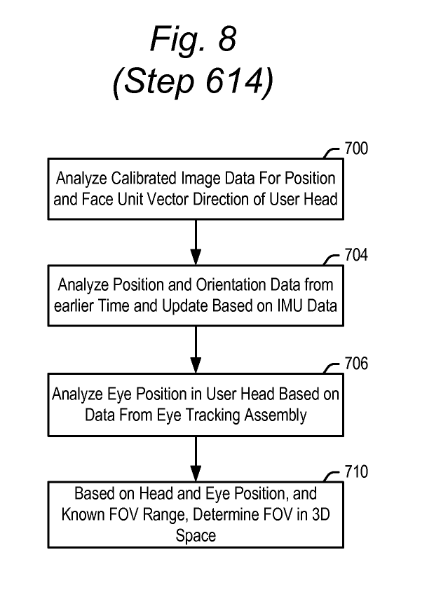

In step 612, the system may detect and track a user's skeleton and/or hands as described above, and update the real world model based on the positions of moving body parts and other moving objects. In step 614, the processing unit 4 determines the x, y and z position, the orientation and the FOV of the head mounted display device 2 within the scene. Further details of step 614 are now described with respect to the flowchart of FIG. 8.

In step 700, the image data for the scene is analyzed by the processing unit 4 to determine both the user head position and a face unit vector looking straight out from a user's face. The head position may be identified from feedback from the head mounted display device 2, and from this, the face unit vector may be constructed. The face unit vector may be used to define the user's head orientation and, in examples, may be considered the center of the FOV for the user. The face unit vector may also or alternatively be identified from the camera image data returned from the room-facing cameras 112 on head mounted display device 2. In particular, based on what the cameras 112 on head mounted display device 2 see, the processing unit 4 is able to determine the face unit vector representing a user's head orientation.

In step 704, the position and orientation of a user's head may also or alternatively be determined from analysis of the position and orientation of the user's head from an earlier time (either earlier in the frame or from a prior frame), and then using the inertial information from the IMU 132 to update the position and orientation of a user's head. Information from the IMU 132 may provide accurate kinematic data for a user's head, but the IMU typically does not provide absolute position information regarding a user's head. This absolute position information, also referred to as “ground truth,” may be provided from the image data obtained from the cameras on the head mounted display device 2.

In embodiments, the position and orientation of a user's head may be determined by steps 700 and 704 acting in tandem. In further embodiments, one or the other of steps 700 and 704 may be used to determine head position and orientation of a user's head.

It may happen that a user is not looking straight ahead. Therefore, in addition to identifying user head position and orientation, the processing unit may further consider the position of the user's eyes in his head. This information may be provided by the eye tracking assembly 134 described above. The eye tracking assembly is able to identify a position of the user's eyes, which can be represented as an eye unit vector showing the left, right, up and/or down deviation from a position where the user's eyes are centered and looking straight ahead (i.e., the face unit vector). A face unit vector may be adjusted to the eye unit vector to define where the user is looking.

In step 710, the FOV of the user may next be determined. The range of view of a user of a head mounted display device 2 may be predefined based on the up, down, left and right peripheral vision of a hypothetical user. In order to ensure that the FOV calculated for a given user includes objects that a particular user may be able to see at the extents of the FOV, this hypothetical user may be taken as one having a maximum possible peripheral vision. Some predetermined extra FOV may be added to this to ensure that enough data is captured for a given user in embodiments.

The FOV for the user at a given instant may then be calculated by taking the range of view and centering it around the face unit vector, adjusted by any deviation of the eye unit vector. In addition to defining what a user is looking at in a given instant, this determination of a user's FOV is also useful for determining what may not be visible to the user. As explained below, limiting processing of virtual objects to those areas that are within a particular user's FOV may improve processing speed and reduces latency.

As also explained below, the present invention may operate in an immersion mode, where the view is a scaled view from the perspective of the user-controlled avatar. In some embodiments, when operating in immersion mode, step 710 of determining the FOV of the real world model may be skipped.

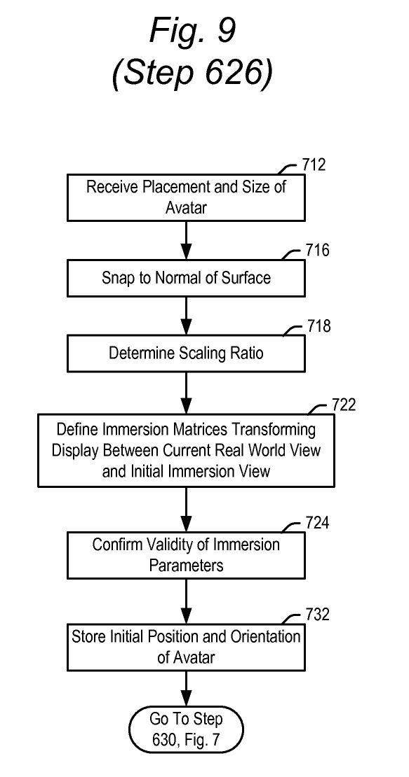

Aspects of the present technology, including the option of viewing virtual content from within an immersion mode, may be implemented by a scaled immersion software engine 458 (FIG. 6) executing on processing unit 4, based on input received via the head mounted display device 2. Viewing of content from within the real world and immersion modes via the content generation engine 458, processing unit 4 and display device 2 will now be explained in greater detail reference to FIGS. 9-18. While the following describes processing steps performed by the processing unit 4, it is understood that these steps may also or alternatively be performed by a processor within the head mounted display device 2 and/or some other computing device.

Interactions with the virtual workpiece from the real world and immersion modes as explained below may be accomplished by the user performing various predefined gestures. Physical and/or verbal gestures may be used to select virtual tools (including the avatar 500) or portions of the workpiece, such as for example by touching, pointing at, grabbing or gazing at a virtual tool or portion of the workpiece. Physical and verbal gestures may be used to modify the avatar or workpiece, such as for example saying, “enlarge avatar by 20%.” These gestures are by way of example only and a wide variety of other gestures may be used to interact with the avatar, other virtual tools and/or the workpiece.

In step 622, the processing unit 4 detects whether the user is initiating the immersion mode. Such an initiation may be detected for example by a user pointing at, grabbing or gazing at the avatar 500, which may be stored on a virtual workbench 502 (FIG. 13) when not being used in the immersion mode. If selection of immersion mode is detected in step 622, the processing unit 4 sets up and validates the immersion mode in step 626. Further details of step 626 will now be explained with reference to FIG. 9.

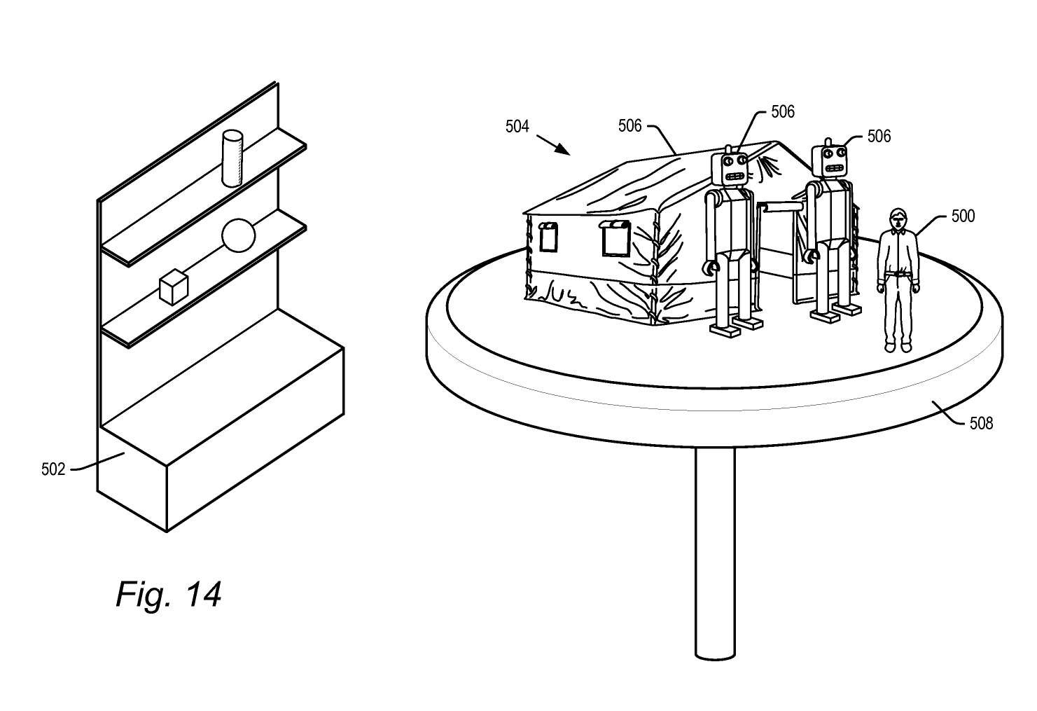

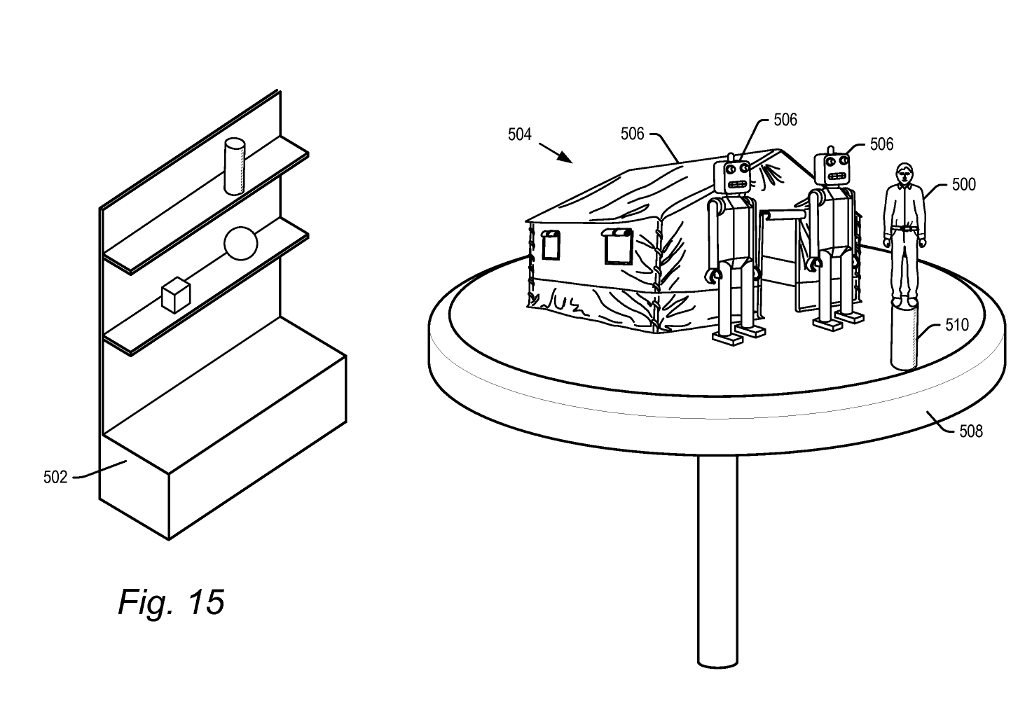

In step 712, the user may position the avatar 500 somewhere in the virtual content 504 as shown in FIG. 14. As noted, the virtual content 504 may include one or more workpieces 506 and spaces in and around the workpieces. The virtual content 504 may also include any virtual objects in general, and spaces around such virtual objects. The one or more workpieces 506 may be seated on a work surface 508, which may be real or virtual. The avatar 500 may be positioned in the virtual content on the work surface 508, or on a surface of a workpiece 506. It is also contemplated that a virtual object 510 (FIG. 15) be placed on the work surface 508 as a pedestal, and the avatar 500 be placed atop the object 510 to change the elevation and hence view of the avatar.

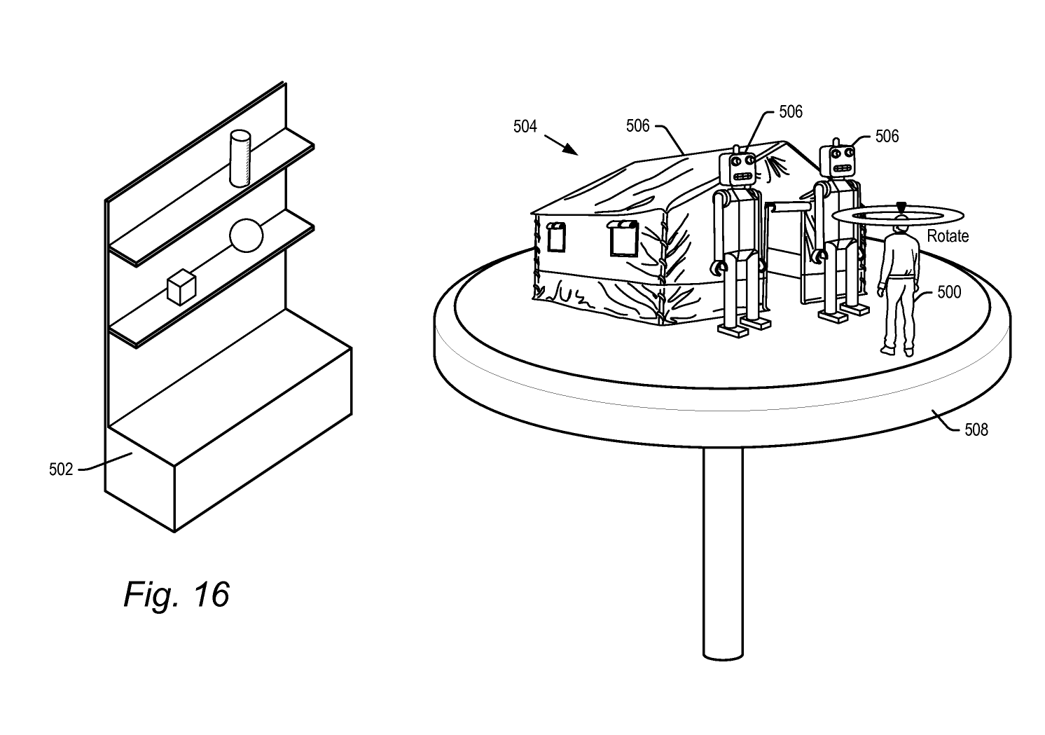

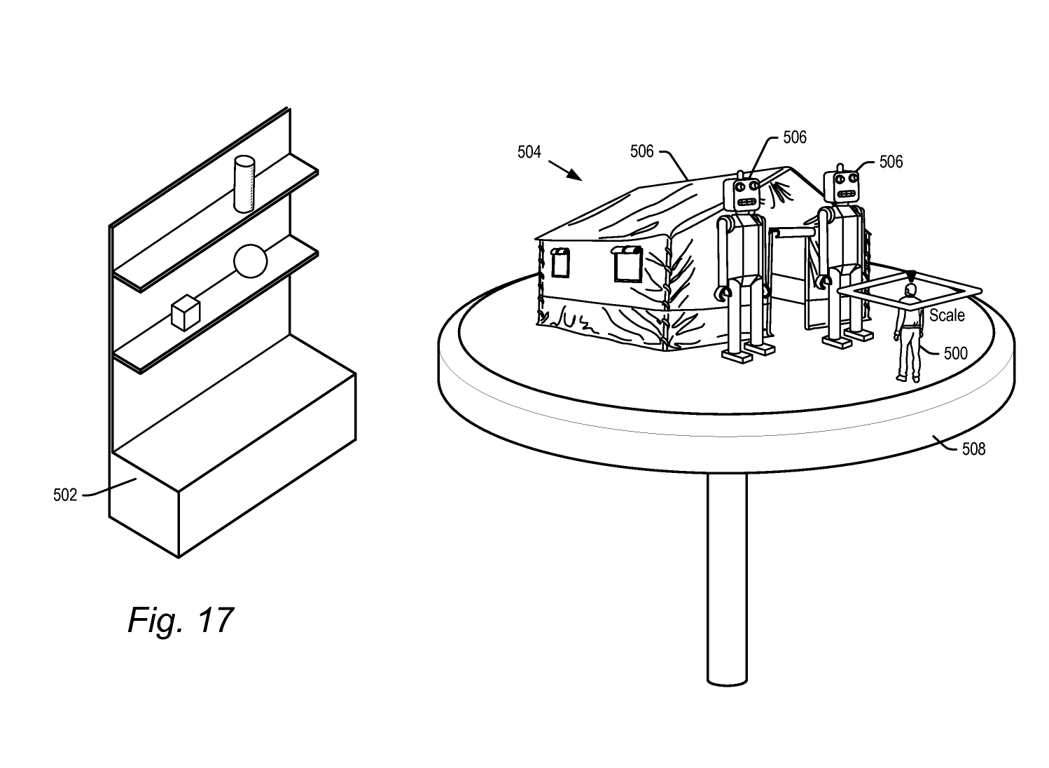

Once the avatar 500 is placed at a desired location, the avatar 500 may be rotated (FIG. 16) and/or scaled (FIG. 17) to the desired orientation and size. When the avatar 500 is placed on a surface, the avatar may snap to a normal of that surface. That is, the avatar may orient along a ray perpendicular to the surface on which the avatar is placed. If the avatar 500 is placed on the horizontal work surface 508, the avatar may stand vertically. If the avatar 500 is placed on a virtual hill or other sloped surface, the avatar may orient perpendicularly to the location of its placement. It is conceivable that an avatar affix to an overhang of a workpiece 506 have an overhang, so that the avatar 500 is positioned upside down.

The scaling of avatar 500 in the virtual content 504 is relevant in that it may be used to determine a scale of the virtual content 504, and a scaling ratio in step 718 of FIG. 9. In particular, as noted above, the processing unit 4 and head mounted device 2 may cooperate to determine the height of a user in real world coordinates. A comparison of the user's real world height to the size of the avatar set by the user (along its long axis) provides the scaling ratio in step 718. For example, where a six-foot tall user sets the z-axis height of the avatar as 6 inches, this provides a scaling ratio of 12:1. This scaling ratio is by way of example only and a wide variety of scaling ratios may be used based on the user's height and the height set for avatar 500 in the virtual content 504. Once a scaling ratio is set, it may be used for all transformations between the real world view and the scaled immersion view until such time as a size of the avatar is changed.

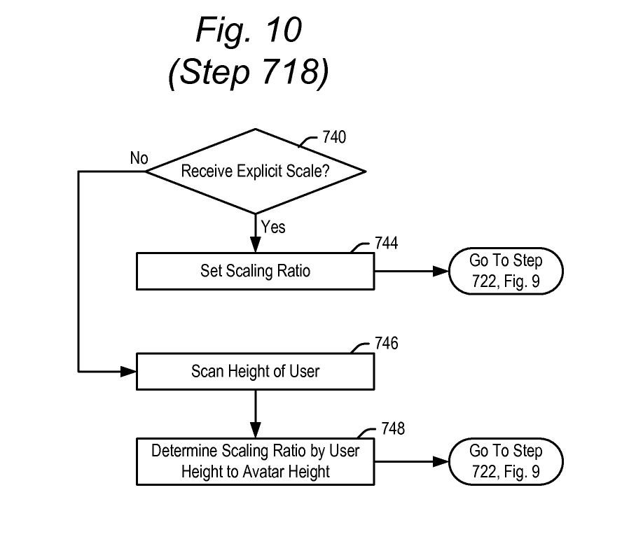

The flowchart of FIG. 10 provides some detail for determining the scaling ratio. Instead of a user's height, it is understood that a user may set and explicit scaling ratio in steps 740 and 744, independent of a user's height and/or a height set for avatar 500. It is further understood that, instead of a user's height, some other real world reference size may be provided by a user and used together with the set height of the avatar 500 in determining the scaling ratio in accordance with the present technology. Steps 746 and 748 show the above-described steps of scanning the height of a user and determining the scaling ratio based on the measured user height and the height of the avatar set by the user. In embodiments, a virtual ruler or other measuring tool (not shown) may be displayed next to the avatar 500, along an axis by which the avatar is being stretched or shrunk, to show the size of the avatar when being resized.

The scaling ratio of step 718 may be used in a few ways in the present technology. For example, workpieces are often created without any scale. However, once the scaling ratio is determined, it may be used to provide scale to the workpiece or workpieces in the virtual content 504. Thus, in the above example, where a workpiece 506 includes for example a wall with a z-axis height of 12 inches, the wall would scale to 12 feet in real world dimensions.

The scaling ratio may also be used to define a change in position in the perspective view of the avatar 500 for a given change in position of the user in the real world. In particular, when in immersion mode, the head mounted display device 2 displays a view of the virtual content 504 from the perspective of the avatar 500. This perspective is controlled by the user in the real world. As the user's head translates (x, y and z) or rotates (pitch, yaw and roll) in the real world, this results in a corresponding scaled change in the avatar's perspective in the virtual content 504 (as if the avatar was performing the same corresponding movement as the user but scaled per the scaling ratio).

Referring again to FIG. 9, in step 722, a set of one or more immersion matrices are generated for transforming the user's view perspective in the real world to the view perspective of the avatar in the virtual content 504 at any given instant in time. The immersion matrices are generated using the scaling ratio, the position (x, y, z) and orientation (pitch, yaw, roll) of the user's view perspective in the real world model, and the position (xᵢ, yᵢ, zᵢ) and orientation (pitchᵢ, yawᵢ, rollᵢ) of the avatar's view perspective set by the user when the avatar is placed in the virtual content. The position (xᵢ, yᵢ, zᵢ) may be a position of a point central to the avatar's face, for example between the eyes, when the avatar is positioned in the virtual content. This point may be determined from a known position and scaled height of the avatar.

The orientation (pitchᵢ, yawᵢ, rollᵢ) may be given by a unit vector from that point, oriented perpendicularly to a facial plane of the avatar. In examples, the facial plane may be a plane parallel to a front surface of the avatar's body and/or head when the avatar is oriented in the virtual content. As noted above, the avatar may snap to a normal of a surface on which it is positioned. The facial plane may be defined as including the normal, and the user-defined rotational position of the avatar about the normal.

Once the position and orientation of the user, the position and orientation of the avatar, and the scaling ratio are known, scaled transformation matrices for transforming between the view of the user and the view of the avatar may be determined. As explained above, transformation matrices are known for translating a first view perspective to a second view perspective in six degrees of freedom. See, for example, David H. Eberly, “3d Game Engine Design: A Practical Approach To Real-Time Computer Graphics,” Morgan Kaufman Publishers (2000). The scaling ratio is applied in the immersion (transformation) matrices so that an x, y, z, pitch, yaw and/or roll movement of the user's view perspective in the real world will result in a corresponding xᵢ, yᵢ, zᵢ, pitchᵢ, yaws and/or roll movement of the avatar's view perspective in the virtual content 504, but scaled according to the scaling ratio.

Thus, as a simple example using the above scaling ration of 12:1, once the immersion matrices are defined in step 722 of FIG. 9, if the user in the real world takes a step of 18 inches along the x-axis, the perspective of the avatar 500 would have a corresponding change of 1.5 inches along the x-axis in the virtual content 504.

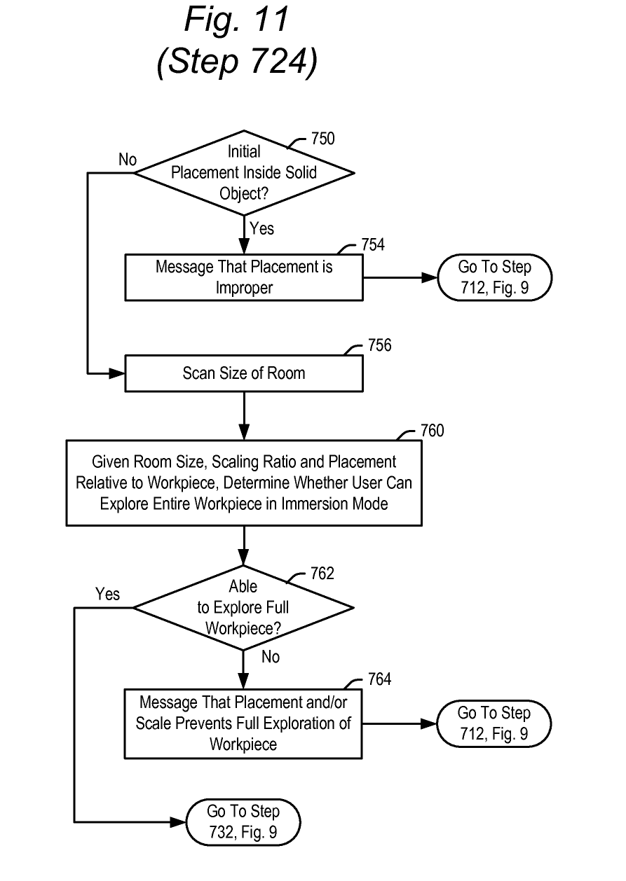

It may happen that certain placements and scale of the avatar 500 in the virtual content 504 result in a suboptimal experience when moving around in the real world and exploring the virtual content in the immersion mode. In step 724 of FIG. 9, the processing unit 4 may confirm the validity of the immersion parameters to ensure the experience is optimized. Further details of step 724 will now be explained with reference to the flowchart of FIG. 11.

In step 750, the processing unit 4 determines whether the user has positioned the avatar 500 within a solid object (real or virtual). As noted above, the processing unit 4 maintains a map of all real and virtual objects in the real world, and is able to determine when a user has positioned the avatar through a surface of a real or virtual object. If it is determined in step 750 that an avatar's eyes or head is positioned within a solid object, the processing unit 4 may cause the head mounted display device 2 to provide a message that the placement is improper in step 754. The user may then return to step 712 and FIG. 9 to adjust the placement and/or scale of the avatar 500.

It may also happen that a user has set the scale of the avatar too small for a user to fully explore the virtual content 504 given the size of the real world room in which the user is using the mobile mixed reality assembly 30. As one of any number of examples, a user may be 10 feet away from a physical wall along the y-axis in the real world. However, with the scale of avatar 500 set by the user, the user would need to walk 15 feet in the y-direction before the avatar's perspective would reach the y-axis boundary of the virtual content. Thus, given the physical boundaries of the room and the scale set by the user, there may be portions of the virtual content which the user would not be able to explore.

Accordingly, in step 756 of FIG. 11, the processing unit 4 and head mounted device 2 may scan the size of the room in which the user is present. As noted, this step may have already been done when gathering scene data in step 604 of FIG. 7, and may not need to be performed as part of step 724. Next, in step 760, with the known room size, scaling ratio and placement of the avatar 500 relative to the workpiece(s), the processing unit 4 determines whether a user would be able to explore all portions of the workpiece(s) 506 when in the immersion mode. In particular, the processing unit determines whether there is enough physical space in the real world to encompass exploration of any portion of the virtual world from the avatar's perspective in immersion mode.

If there is not enough space in the physical world, the processing unit 4 may cause the head mounted display device 2 to provide a message that the placement and/or scale of the avatar 500 prevents full exploration of the virtual content 504. The user may then return to step 712 in FIG. 9 to adjust the placement and/or scale of the avatar 500.

If no problem with the placement and/or scale of the avatar 500 is detected in step 724, the initial position and orientation of the avatar may be stored in step 732 of FIG. 9, together with the determined scaling ratio and immersion matrices. It is understood that at least portions of step 724 for confirming the validity of the immersion parameters may be omitted in further embodiments.

Referring again to FIG. 7, once the immersion mode has been set up and validated in step 626, the processing unit 4 may detect whether the user is operating in immersion mode. As noted above, this may be detected when the avatar has been selected and is positioned in the virtual content 504. A switch to immersion mode may be triggered by some other, predefined gesture in further embodiments. If operating in immersion mode in step 630, the processing unit 4 may look for a predefined gestural command to leave the immersion mode in step 634. If either not operating in immersion mode in step 630 or a command to leave the immersion mode is received in step 634, the perspective to be displayed to the user may be set to the real world view in step 642. The image may then be rendered as explained hereinafter with respect to steps 644-656.

When a user provides a command to leave the immersion mode in step 634, a few different things may happen with respect to the avatar 500 in alternative embodiments of the present technology. The real world view may be displayed to the user, with the avatar 500 removed from the virtual content and returned to the workbench 502.

In further embodiments, the real world view may be displayed to the user, with the avatar 500 shown at the position and orientation of the perspective when the user chose to exit the immersion mode. Specifically, as discussed above, where a user has moved around when in the immersion mode, the position of the avatar 500 changes by a corresponding scaled amount. Using the position and orientation of the user at the time the user left immersion mode, together with the immersion matrices, the processing unit 4 may determine the real the position of the avatar 500 in the real world model. The avatar may be displayed at that position and orientation upon exiting immersion mode.

In further embodiments, upon exiting immersion mode, the real world view may be displayed to the user with the avatar 500 shown in the initial position set by the user when the user last entered the immersion mode. As noted above, this initial position is stored in memory upon set up and validation of the immersion mode in step 626.

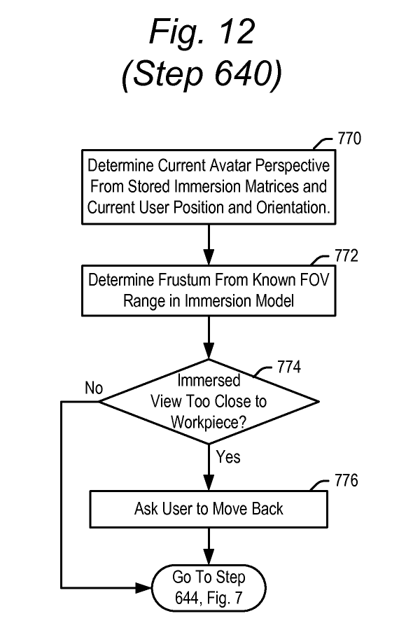

Referring again to FIG. 7, if a user is operating in immersion mode in step 630 and no exit command is received in step 634, then the mode is set to the immersion mode view in step 638. When in immersion mode, the head mounted display device 2 displays the virtual content 504 from the avatar's perspective and orientation. This position and orientation, as well as the frustum of the avatar's view, may be set in step 640. Further details of step 640 will now be explained with reference to the flowchart of FIG. 12.

In step 770, the processing unit 4 may determine the current avatar perspective (position and orientation about six degrees of freedom) from the stored immersion matrices and the current user perspective in the real world. In particular, as discussed above with respect to step 700 in FIG. 8, the processing unit 4 is able to determine a face unit vector representing a user's head position and orientation in the real world based on data from the head mounted display device 2. Upon application of the immersion matrices to the user's x, y and z head position and unit vector, the processing unit 4 is able to determine an xᵢ, yᵢ and zᵢ position for the perspective of the virtual content in the immersion mode. Using the immersion matrices, the processing unit 4 is also able to determine an immersion mode unit vector representing the orientation from which the virtual content is viewed in the immersion mode.

In step 772, the processing unit 4 may determine the extent of a frustum (analogous to the FOV for the head mounted display device). The frustum may be centered around the immersion mode unit vector. The processing unit 4 may also set the boundaries of the frustum for the immersion mode view in step 772. As described above with respect to setting the FOV in the real world view (step 710, FIG. 8), the boundaries of the frustum may be predefined as the range of view based on the up, down, left and right peripheral vision of a hypothetical user, centered around the immersion mode unit vector. Using the information determined in steps 770 and 772, the processing unit 4 is able to display the virtual content 504 from the perspective and frustum of the avatar's view.

It may happen that prolonged viewing of an object (virtual or real) at close range may result in eye strain. Accordingly, in step 774, the processing unit may check whether the view in immersion mode is too close to a portion of the workpiece 506. If so, the processing unit 4 may cause the head mounted display device 2 to provide a message in step 776 for the user to move further away from the workpiece 506. Steps 774 and 776 may be omitted in further embodiments.

Referring again to FIG. 7, in step 644, the processing unit 4 may cull the rendering operations so that just those virtual objects which could possibly appear within the final FOV or frustum of the head mounted display device 2 are rendered. If the user is operating in the real world mode, virtual objects are taken from the user's perspective in step 644. If the user is operating in immersion mode, the virtual objects are taken from the avatar's perspective are used in step 644. The positions of other virtual objects outside of the FOV/frustum may still be tracked, but they are not rendered. It is also conceivable that, in further embodiments, step 644 may be skipped altogether and the entire image is rendered from either the real world view or immersion view.

The processing unit 4 may next perform a rendering setup step 648 where setup rendering operations are performed using the real world view and FOV received in steps 610 and 614, or using the immersion view and frustum received in steps 770 and 772. Once virtual object data is received, the processing unit may perform rendering setup operations in step 648 for the virtual objects which are to be rendered. The setup rendering operations in step 648 may include common rendering tasks associated with the virtual object(s) to be displayed in the final FOV/frustum. These rendering tasks may include for example, shadow map generation, lighting, and animation. In embodiments, the rendering setup step 648 may further include a compilation of likely draw information such as vertex buffers, textures and states for virtual objects to be displayed in the predicted final FOV.

Using the information regarding the locations of objects in the 3-D real world model, the processing unit 4 may next determine occlusions and shading in the user's FOV or avatar's frustum in step 654. In particular, the processing unit 4 has the three-dimensional positions of objects of the virtual content. For the real world mode, knowing the location of a user and their line of sight to objects in the FOV, the processing unit 4 may then determine whether a virtual object partially or fully occludes the user's view of a real or virtual object. Additionally, the processing unit 4 may determine whether a real world object partially or fully occludes the user's view of a virtual object.

Similarly, if operating in immersion mode, the determined perspective of the avatar 500 allows the processing unit 4 to determine a line of sight from that perspective to objects in the frustum, and whether a virtual object partially or fully occludes the avatar's perspective of a real or virtual object. Additionally, the processing unit 4 may determine whether a real world object partially or fully occludes the avatar's view of a virtual object.

In step 656, the GPU 322 of processing unit 4 may next render an image to be displayed to the user. Portions of the rendering operations may have already been performed in the rendering setup step 648 and periodically updated. Any occluded virtual objects may not be rendered, or they may be rendered. Where rendered, occluded objects will be omitted from display by the opacity filter 114 as explained above.

In step 660, the processing unit 4 checks whether it is time to send a rendered image to the head mounted display device 2, or whether there is still time for further refinement of the image using more recent position feedback data from the head mounted display device 2. In a system using a 60 Hertz frame refresh rate, a single frame is about 16 ms.

If time to display an updated image, the images for the one or more virtual objects are sent to microdisplay 120 to be displayed at the appropriate pixels, accounting for perspective and occlusions. At this time, the control data for the opacity filter is also transmitted from processing unit 4 to head mounted display device 2 to control opacity filter 114. The head mounted display would then display the image to the user in step 662.

On the other hand, where it is not yet time to send a frame of image data to be displayed in step 660, the processing unit may loop back for more recent sensor data to refine the predictions of the final FOV and the final positions of objects in the FOV. In particular, if there is still time in step 660, the processing unit 4 may return to step 604 to get more recent sensor data from the head mounted display device 2.

The processing steps 600 through 662 are described above by way of example only. It is understood that one or more of these steps may be omitted in further embodiments, the steps may be performed in differing order, or additional steps may be added.

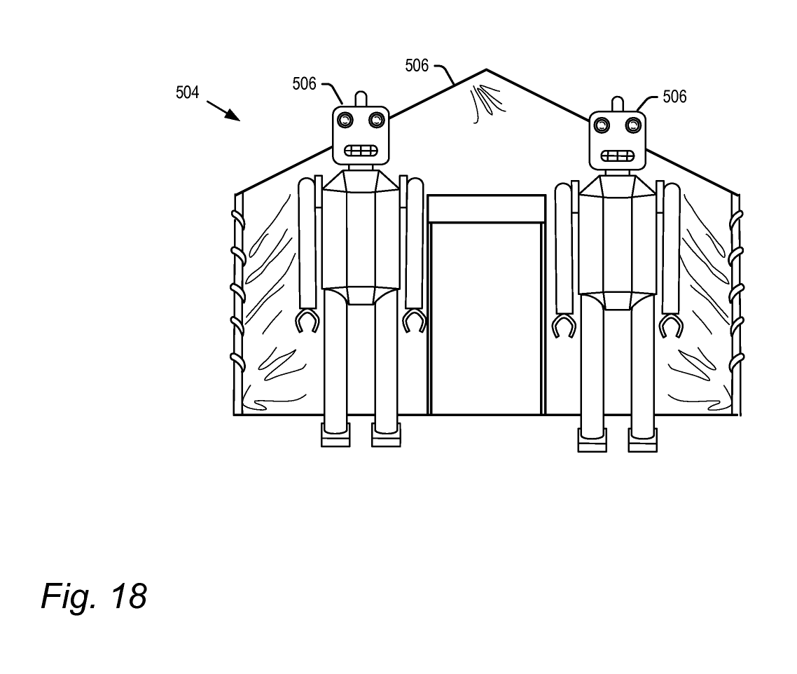

FIG. 18 illustrates a view of the virtual content 504 from the immersion mode which may be displayed to a user given the avatar position and orientation shown in FIG. 17. The view of the virtual content 504 when in immersion mode provides a life-size view, where the user is able to discern detailed features of the content. Additionally, the view of the virtual content from within immersion mode provides perspective in that the user is able to see how big virtual objects are in life-size.

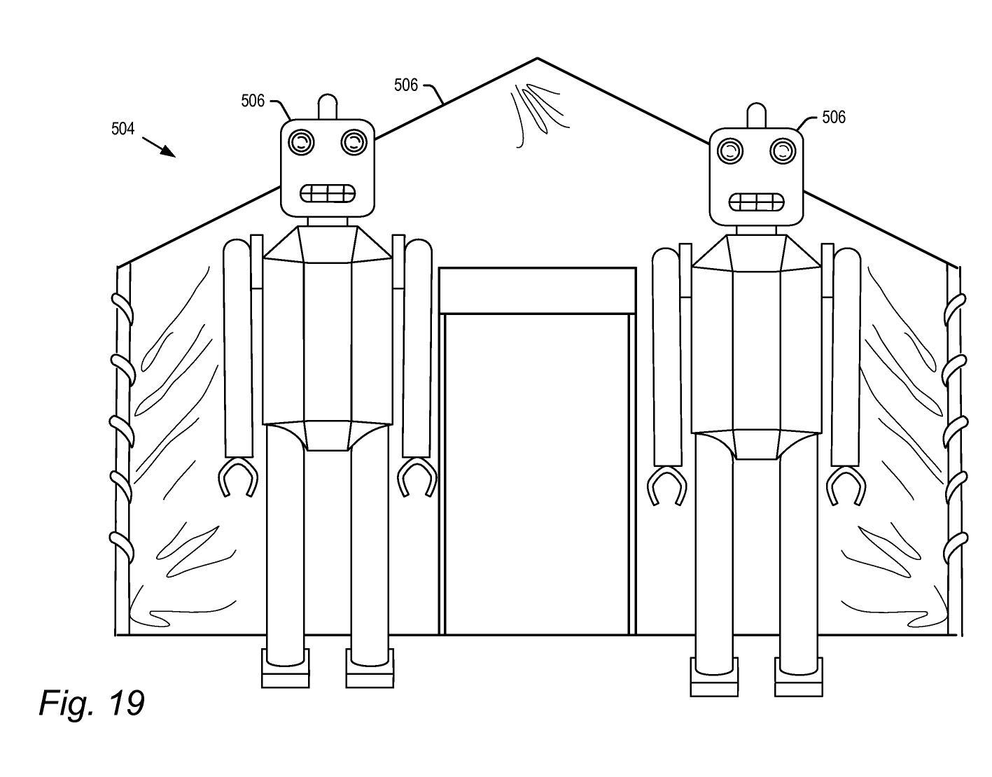

Movements of the user in the real world may result in the avatar moving toward a workpiece 506, and the avatar's perspective of the workpiece 506 growing correspondingly larger, as shown in FIG. 19. Other movements of the user may result in the avatar moving away from the workpiece 506 and/or exploring other portions of the virtual content 504.

In addition to viewing and exploring the virtual content 504 from within immersion mode, in embodiments, the user is able to interact with and modify the virtual content 504 from within immersion mode. A user may have access to a variety of virtual tools and controls. A user may select a portion of a workpiece, a workpiece as a whole, or a number of workpieces 506 using predefined gestures, and thereafter apply a virtual tool or control to modify the portion of the workpiece or workpieces. As a few examples, a user may move, rotate, color, remove, duplicate, glue, copy, etc. one or more selected portions of the workpiece(s) in accordance with the selected tool or control.

A further advantage of the immersion mode of the present technology is that it allows the user to interact with the virtual content 504 with enhanced precision. As an example, where a user is attempting to select a portion of the virtual content 504 from the real world view, using for example pointing or eye gaze, the sensors of the head mounted display device are able to discern an area of a given size on the virtual content that may be the subject of the user's point or gaze. It may happen that the area may have more than one selectable virtual object, in which case it may be difficult for the user to select the specific object that the user wishes to select.

However, when operating in immersion mode where the user's view perspective is scaled to the size of the virtual content, that same pointing or gaze gesture will result in a smaller, more precise area that is the subject of the user's point or gaze. As such, the user may more easily select items with greater precision.

Additionally, modifications to virtual objects of a workpiece may be performed with more precision in immersion mode. As an example, a user may wish to move a selected virtual object of a workpiece a small amount. In real world mode, the minimum incremental move may be some given distance and it may happen that this minimum incremental distance is still larger than the user desires. However, when operating in immersion mode, the minimum incremental distance for a move may be smaller than in real world mode. Thus, the user may be able to make finer, more precise adjustments to virtual objects within immersion mode.

Using predefined gestural commands, a user may toggle between the view of the virtual content 504 from the real world, and the view of the virtual content 504 from the avatar's immersion view. It is further contemplated that a user may position multiple avatars 500 in the virtual content 504. In this instance, the user may toggle between a view of the virtual content 504 from the real world, and the view of the virtual content 504 from the perspective of any one of the avatars.

In summary, one example of the present technology relates to a system for presenting a virtual environment coextensive with a real world space, the system comprising: a head mounted display device including a display unit for displaying three-dimensional virtual content in the virtual environment; and a processing unit operatively coupled to the display device, the processing unit receiving input determining whether the virtual content is displayed by the head mounted display device in a first mode where the virtual content is displayed from a real world perspective of the head mounted display device, or displayed by the head mounted display device in a second mode where the virtual content is displayed from a scaled perspective of a position and orientation within the virtual content.

In another example, the present technology relates to a system for presenting a virtual environment coextensive with a real world space, the system comprising: a head mounted display device including a display unit for displaying three-dimensional virtual content in the virtual environment; and a processing unit operatively coupled to the display device, the processing unit receiving a first input of a placement of a virtual avatar in or around the virtual content at a position and orientation relative to the virtual content and with a size scaled relative to the virtual content, the processing unit determining a transformation between a real world view of the virtual content from the head mounted display device and an immersion view of the virtual content from a perspective of the avatar, the transformation determined based on the position, orientation and size of the avatar, a position and orientation of the head mounted display and a received or determined reference size, the processing unit receiving at least a second input to switch between displaying the real world view and the immersion view by the head mounted display device.

In a further example, the present technology relates to a method of presenting a virtual environment coextensive with a real world space, the virtual environment presented by a head mounted display device, the method comprising: (a) receiving placement of a virtual object at a position in the virtual content; (b) receiving an orientation of the virtual object; (c) receiving a scaling of the virtual object; (d) determining a set of one or more transformation matrices based on the position and orientation of the head mounted display, the position of the virtual object received in said step (a) and orientation of the virtual object received in said step (b); (e) moving the virtual object around within the virtual content based on movements of the user; and (f) transforming a display by the head mounted display device from a view from the head mounted display device to a view taken from the virtual object before and/or after moving in said step (e) based on the set of one or more transformation matrices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A system for presenting a virtual environment coextensive with a real world space, the system comprising:
a head mounted display device including a display unit for displaying three-dimensional virtual content in the virtual environment; and
a processing unit operatively coupled to the display device, the processing unit receiving input determining whether the virtual content is displayed by the head mounted display device in a first mode where the virtual content is displayed from a real world perspective of the head mounted display device, or displayed by the head mounted display device in a second mode where the virtual content is displayed from a scaled perspective of a position and orientation within the virtual content.

2. The system of claim 1, wherein a scale, position and orientation of the scaled perspective in the second mode are determined by a position of an avatar within the virtual content.

3. The system of claim 2, wherein the scale, position and orientation of the scaled perspective in the second mode are taken from a perspective of a head of the virtual avatar within the virtual content.

4. The system of claim 2, wherein the scale the scaled perspective is determined by a user-defined size of the avatar.

5. The system of claim 2, wherein the scale the scaled perspective is determined by a user-defined size of the avatar relative to a size of the user.

6. The system of claim 1, wherein the position and orientation of the scaled perspective from which the virtual content is displayed changes in a corresponding and scaled manner to movement of the head mounted display device.

7. The system of claim 1, the processing unit receiving placement of a virtual avatar within the virtual content, a size, position and orientation of the avatar determining the scaled perspective in the second mode.

8. The system of claim 7, wherein a position and orientation of the avatar changes in a corresponding and scaled manner to movement of the head mounted display device.

9. A system for presenting a virtual environment coextensive with a real world space, the system comprising:
a head mounted display device including a display unit for displaying three-dimensional virtual content in the virtual environment; and
a processing unit operatively coupled to the display device, the processing unit receiving a first input of a placement of a virtual avatar in or around the virtual content at a position and orientation relative to the virtual content and with a size scaled relative to the virtual content, the processing unit determining a transformation between a real world view of the virtual content from the head mounted display device and an immersion view of the virtual content from a perspective of the avatar, the transformation determined based on the position, orientation and size of the avatar, a position and orientation of the head mounted display and a received or determined reference size, the processing unit receiving at least a second input to switch between displaying the real world view and the immersion view by the head mounted display device.

10. The system of claim 9, wherein at least one of the head mounted display device and processing unit detect movement of the head mounted display device, said movement of the head mounted display device resulting in a corresponding movement of the avatar relative to the virtual content.

11. The system of claim 10, wherein the movement of the avatar changes the immersion view.

12. The system of claim 10, wherein the movement of the avatar is scaled relative to movement of the user, wherein the scaled movement is based on the scaled size of the avatar relative to the reference size.

13. The system of claim 12, wherein the reference size is a height of a user wearing the head mounted display device.

14. The system of claim 13, the processing unit further determining whether the avatar may explore a full extent of the virtual content based on the scaled movement of the avatar and physical boundaries of a space in which the user is wearing the head mounted display device.

15. The system of claim 13, further comprising receipt of at least a third input for modifying at least a portion of the virtual content while displaying the immersion view by the head mounted display device, the processing unit modifying the portion of the virtual content in response to the third input.

16. The system of claim 15, wherein a precision with which the virtual content is modified while displaying the immersion view is greater than a precision with which the virtual content is modified while displaying the real world view.

17. A method of presenting a virtual environment coextensive with a real world space, the virtual environment presented by a head mounted display device, the method comprising:
(a) receiving placement of a virtual object at a position in the virtual content;
(b) receiving an orientation of the virtual object;
(c) receiving a scaling of the virtual object;
(d) determining a set of one or more transformation matrices based on the position and orientation of the head mounted display, the position of the virtual object received in said step (a) and orientation of the virtual object received in said step (b);
(e) moving the virtual object around within the virtual content based on movements of the user; and
(f) transforming a display by the head mounted display device from a view from the head mounted display device to a view taken from the virtual object before and/or after moving in said step (e) based on the set of one or more transformation matrices.

18. The method of claim 17, further comprising the step (g) of determining a scaling ratio based on a scaled size of the virtual object received in said step (c) relative to a real world reference size, the set of one or more transformation matrices further determined based on the scaling ratio.

19. The method of claim 17, wherein the real world reference size in said step (g) is a size of a user wearing the head mounted display device.

20. The method of claim 17, wherein the virtual object in said steps (a), (b) and (c) is an avatar which is a virtual replica of a user wearing the head mounted display device.
